(19) United States
(12) Patent Application Publication
(10) Pub. No.: US 2010/0045120 A1
(43) Pub. Date: Feb. 25, 2010

(54) MAGNETIC POWDER, DUST CORE, MOTOR, AND REACTOR

(75) Inventors: Tomoyasu Kitano, Nissin-shi (JP); Eisuke Hoshina, Toyota-shi (JP); Daisuke Ichigozaki, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi (JP)

(21) Appl. No.: 12/518,408

(22) PCT Filed: Dec. 28, 2007
(86) PCT No.: PCT/JP2007/075425

§ 371 Date: Jun. 9, 2009

(30) Foreign Application Priority Data
Jan. 12, 2007 (JP) 2007-004113

(51) Int. Cl. H02K 15/12; H01F 1/26; H01F 27/255

(52) U.S. Cl. 310/44; 252/62.51 R; 252/62.55; 336/233

(57) ABSTRACT

According to the present invention, a magnetic powder for a dust core, which is excellent in terms of insulation properties without causing a decrease in the dust core magnetic flux density, a dust core comprising the magnetic powder, and a motor or a reactor having a core composed of the dust core are provided. Therefore, a magnetic powder 10 for a dust core is characterized in that relatively hard oxide fine powder particles 2 are dispersed over and fixed to the surface of a soft magnetic metal powder particle 1, and that a relatively soft insulating coat 3 is fixed to the oxide fine powder particles 2 and portions where the dispersed and fixed oxide fine powder particles 2 do not exist on the surface of the soft magnetic metal powder particle 1.

### TECHNICAL FIELD

The present invention relates to a magnetic powder, a dust core obtained via pressure forming of the magnetic powder, and a motor and a reactor to which the dust core is applied.

### BACKGROUND ART

In view of reducing environmental burdens, the development of hybrid vehicles and electric vehicles has been conducted day by day in the automobile industry. In particular, one urgent development objective is to realize a high-performance and downsized motor or reactor, which is a main apparatus mounted on vehicles.

A stator core or a rotor core, which constitutes a motor, and a reactor core, which constitutes a reactor, are each composed of a steel sheet laminate in which silicon steel sheets are laminated or of a dust core obtained via pressure forming of a resin-coated iron-based soft magnetic powder. A variety of cores formed with dust cores are advantageous in terms of magnetic properties that result in lower high-frequency iron loss than in the case in which laminated steel sheets are used, a variety of shapes that can result from pressure-forming in a flexible manner at low costs, and materials costs lower than those for silicon steel sheets (electromagnetic steel sheets).

In the case of a soft magnetic metal powder for a dust core, an insulating coat is formed on the surface of a soft magnetic metal powder particle such that not only powder insulation properties but also insulation properties of a dust core itself can be secured, resulting in inhibition of the occurrence of iron loss. For instance, a method for forming such an insulating coat is described in Patent Document 1 in which a soft magnetic powder is disclosed. Specifically, such a soft magnetic powder is produced in the following manner. An extremely thin silicone resin film with a thickness of 0.1 to 5 μm is formed on the surface of a soft magnetic powder particle or the surface of a phosphate film-coated soft magnetic powder particle. The obtained silicone-resin-film-coated soft magnetic powder is heated from room temperature to 150° C.

In the case of the soft magnetic powder disclosed in Patent Document 1, the powder is used as a material and subjected to pressure forming to result in a predetermined shape. Upon pressure forming, an annealing treatment is carried out in order to reduce processing strain generated in a dust core. However, it is highly probable that an insulating coat would be damaged in a high-temperature atmosphere during the annealing treatment. Specifically, magnetic powder particles “c,” each of which comprises a soft magnetic powder particle “a” and a silicone resin coat “b” formed on the surface of the soft magnetic powder particle as shown in FIG. 6a, are subjected to pressure forming and high-temperature annealing. Accordingly, as shown in FIG. 6 b, the silicone resin is melted in a high-temperature atmosphere and agglutinated in a space surrounded by 3 powder particles, resulting in inhibition of powder insulation properties.

Hence, as conventional means for solving the above problems, magnetic powders disclosed in Patent Documents 2 and 3 and the like can be used. The magnetic powder disclosed in Patent Document 2 is a soft magnetic metal powder having a three-or-more-layered structure in which an insulating coat comprising an oxide and the like is formed on the surface of a soft magnetic metal powder particle and a silicone resin coat is further formed thereon. Such structure is explained based on FIG. 7. An insulating coat “d” comprising an oxide and the like is formed on the surface of a soft magnetic metal powder particle “a” and a silicone resin coat “b” is further formed thereon such that a magnetic powder particle “c′” is obtained.

Further, in the case of the magnetic powder disclosed in Patent Document 3, a first insulating coat is formed on the surface of a soft magnetic metal powder particle and a second insulating coat comprising a silicone resin is formed thereon. Oxide particles are dispersed in the second insulating coat, and a third insulating coat is further formed on the second insulating coat.

Patent Document 1:

JP Patent Publication (Kokai) No. 2005-133168 A

Patent Document 2:

JP Patent Publication (Kokai) No. 2006-128521 A

Patent Document 3:

JP Patent Publication (Kokai) No. 2006-5173 A

### DISCLOSURE OF THE INVENTION

In the cases of the magnetic powders of Patent Documents 2 and 3, the surface of a soft magnetic metal powder particle is not directly covered with a silicone resin. Such a soft magnetic metal powder particle is covered with 2 or more coat layers. Therefore, it is possible to solve the problem of a silicone resin being agglutinated upon high-temperature annealing, which thus leads to magnetic powder insulation properties being inhibited. However, as a result of an increase in the amount of coating on the surface of a soft magnetic metal powder particle, the metal powder particle density relatively decreases. Consequently, the magnetic flux density inevitably decreases and thus desired magnetic properties cannot be obtained, which is seriously problematic.

The present invention has been made in view of the above problems. It is an objective of the present invention to provide a magnetic powder for a dust core, which is excellent in terms of insulation properties without causing a decrease in the dust core magnetic flux density, a dust core comprising the magnetic powder, and a motor or a reactor having a core composed of the dust core.

In order to achieve the above objective, the magnetic powder of the present invention is a magnetic powder for a dust core, characterized in that relatively hard oxide fine powder particles are dispersed over and fixed to the surface of a soft magnetic metal powder particle, and that a relatively soft insulating coat is fixed to the oxide fine powder particles and portions where the dispersed and fixed oxide fine powder particles do not exist on the surface of the soft magnetic metal powder particle.

Herein, examples of a soft magnetic metal powder that can be used include powders made from iron, iron-silicone based alloys, iron-nitrogen based alloys, iron-nickel based alloys, iron-carbon based alloys, iron-boron based alloys, iron-cobalt based alloys, iron-phosphorus based alloys, iron-nickel-cobalt based alloys, and iron-aluminium-silicone based alloys.

In the case of the magnetic powder of the present invention, hard oxide fine powder particles are dispersed in an island shape over the surface of a soft magnetic metal powder particle and fixed thereto. An insulating coat is fixed to the dispersed oxide fine powder particles and to portions where the fixed oxide fine powder particles do not exist on the surface of a soft magnetic metal powder particle. In such manner, the magnetic powder is formed.

It is desirable that an insulating coat be made from an appropriate resin material having insulation properties and heat resistance, and that it be possible for such resin material to bind (cross-linked) to oxide fine powder particles that are dispersed over and fixed to the surface of a soft magnetic metal powder.

In the case of the above magnetic powder composition, an insulating coat made from a resin material is strongly bound not only to a soft magnetic metal powder particle but also to oxide fine powder particles that are dispersed over and fixed to the surface of a soft magnetic metal powder particle. Thus, the oxide fine powder promotes adhesion effects between the soft magnetic metal powder and the insulating coat. Accordingly, it becomes possible to solve the problem of a silicone resin being agglutinated upon high-temperature annealing, which thus leads to magnetic powder insulation properties being inhibited. Further, oxide fine powder particles are dispersed, that is to say, an oxide coating layer is not formed over the entire surface of a soft magnetic metal powder particle. Therefore, it is possible to prevent a decrease in the metal powder proportion in the magnetic powder. As a result, the magnetic flux density of the dust core formed with the magnetic powder does not decrease.

In addition, in preferred embodiments of the magnetic powder of the present invention, the soft magnetic metal powder is characterized in that it is made from pure iron.

Instead of pure iron, it is possible to produce the soft magnetic metal powder from the aforementioned alloys mainly comprising iron. However, in a case in which the soft magnetic metal powder is produced from pure iron, the material cost can be lower than the costs for other alloys. Further, the metal density in a magnetic powder becomes greater than that in a case of an iron-silicone based alloy or the like. As a result, a dust core having a high magnetic flux density can be formed.

Further, in preferred embodiments of the magnetic powder of the present invention, the magnetic powder is characterized in that a single coat layer comprising the insulating coat and the oxide fine powder particles is formed on the surface of a soft magnetic metal powder particle.

When a magnetic powder particle is formed with a soft magnetic metal powder particle serving as the core and a single coat layer that is the outer layer thereof, the metal density can be further increased. Thus, a dust core having an improved magnetic flux density can be obtained.

In addition, the oxide fine powder is produced from silica (SiO₂) and the insulating coat is produced from a silicone resin. In such case, due to good binding between the silica and the silicone resin, effects of preventing agglutination of the silicone resin at high temperatures can be improved.

When a forming die is filled with the above magnetic powder followed by pressure forming, drying, cooling, and then annealing, a dust core having a high magnetic flux density and high insulation properties can be obtained. In addition, demonstration experiments conducted by the present inventors proved that the coverage with an oxide fine powder is preferably 20% to 80% on the premise that it is possible to reduce iron loss including hysteresis loss and eddy current loss and to increase the magnetic flux density that is determined based on the magnetic powder particle density (the soft magnetic metal powder proportion).

The dust core having excellent magnetic properties is preferable as a core (reactor core) for a stator or a rotor that constitutes a driving motor for hybrid vehicles and electric vehicles and it is also preferable as a core for a reactor that constitutes a power converter.

As is understood from the above descriptions, according to the magnetic powder and the dust core comprising the magnetic powder of the present invention, agglutination of an insulating coat can be effectively prevented upon high-temperature annealing such that high insulation properties can be achieved. Further, oxide fine powder particles are dispersed over and fixed to the surface of a soft magnetic metal powder particle and an insulating coat is formed on portions where the oxide fine powder particles do not exist, resulting in an increase in the proportion of an iron component (achievement of a high density). Thus, a dust core having a high magnetic flux density can be obtained.

### BRIEF DESCRIPTION OF THE DRAWINGS

FIG. 1 (a) shows a cross-sectional view of a magnetic powder particle in one embodiment of the present invention. FIG. 1 (b) shows an enlarged view of a portion of a dust core.

FIG. 2 shows a flow chart of the dust core production process.

FIGS. 3 (a) to (d) each schematically show an explanatory diagram of a method wherein silica fine powder particles are dispersed over and fixed to the surface of a soft magnetic metal powder particle. FIG. 3 (a) shows a step of preparing a solution. FIG. 3 (b) shows a step of introducing an iron powder. FIG. 3 (c) shows a step of filtration. FIG. 3 (d) shows a cross-sectional view of a produced iron powder particle having silica fine powder particles dispersed thereon.

FIG. 4 shows experimental results indicating the relationship between the surface area covered with silica fine powder particles on the iron powder particle surface and iron loss.

FIG. 5 shows experimental results indicating the relationship between the surface area covered with silica fine powder particles on the iron powder particle surface and magnetic powder particle density.

FIGS. 6 (a) and (b) each show a cross-sectional view of a conventional magnetic powder particle in one embodiment. FIG. 6 (a) shows a single magnetic powder particle. FIG. 6 (b) shows a plurality of magnetic powder particles subjected to annealing.

FIGS. 7 (a) and (b) each show a cross-sectional view of a conventional magnetic powder particle in another embodiment. FIG. 7 (a) shows a single magnetic powder particle. FIG. 7 (b) shows a plurality of magnetic powder particles subjected to annealing.

In the figures, the numerals “1,” “2,” “3,” and “10” denote an iron powder particle (a soft magnetic metal powder particle), a silica fine powder particle (an oxide fine powder particle), a silicone resin film (an insulating coat), and a magnetic powder particle, respectively.

### BEST MODE FOR CARRYING OUT THE INVENTION

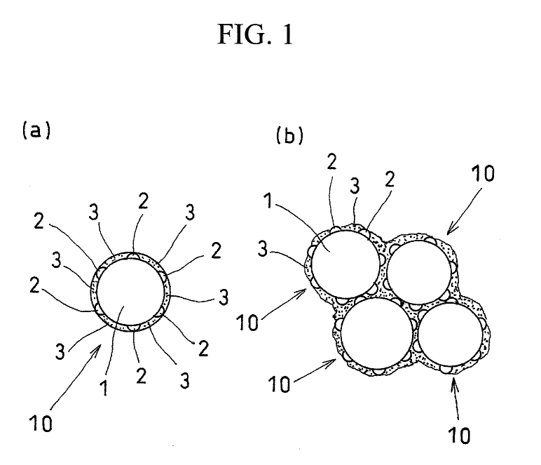

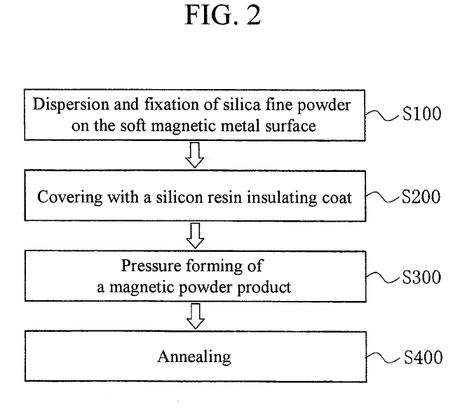

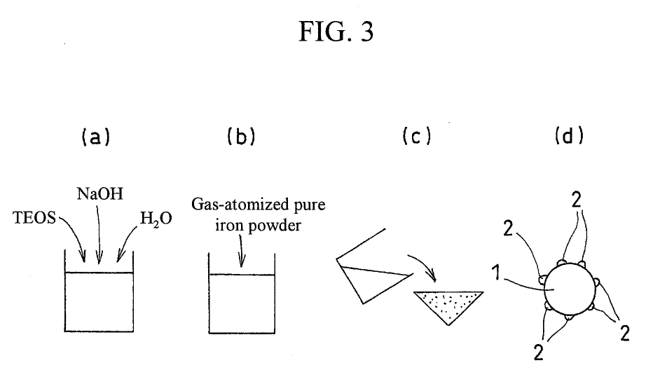

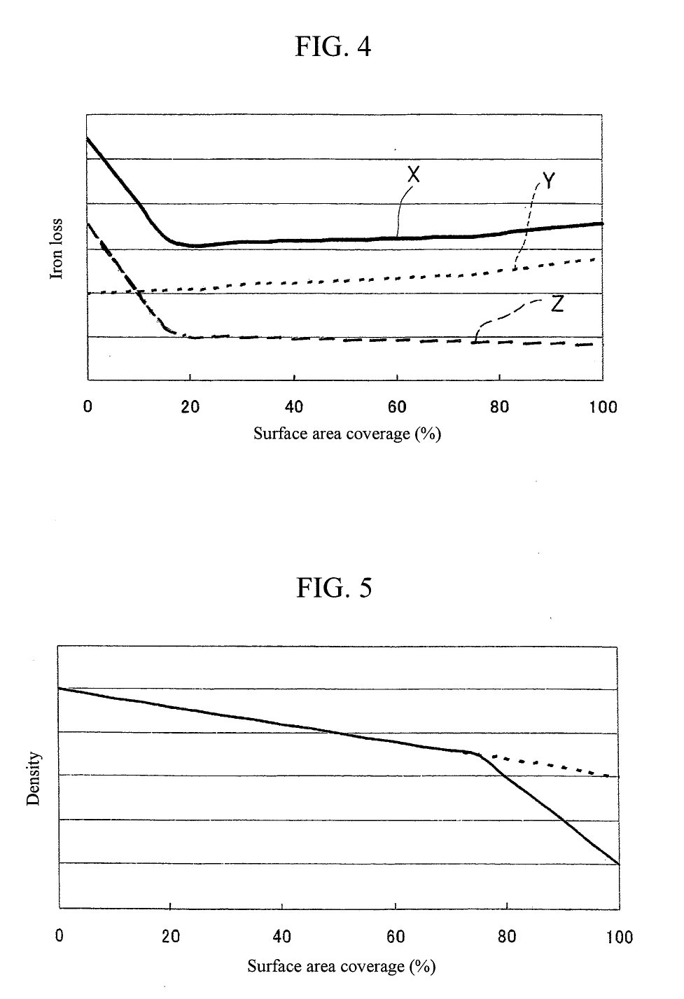

Hereinafter, embodiments of the present invention are described with reference to the drawings. FIG. 1 (a) shows a cross-sectional view of a magnetic powder particle in one embodiment of the present invention. FIG. 1b shows an enlarged view of a portion of a dust core. FIG. 2 shows a flow chart of the dust core production process. FIGS. 3 (a) to (d) each schematically show an explanatory diagram of a method wherein silica fine powder particles are dispersed over and fixed to the surface of a soft magnetic metal powder particle. FIG. 3 (a) shows a step of preparing a solution. FIG. 3 (b) shows a step of introducing an iron powder. FIG. 3 (c) shows a step of filtration. FIG. 3 (d) shows a cross-sectional view of a produced iron powder particle having silica fine powder particles dispersed thereon. FIG. 4 shows experimental results indicating the relationship between the surface area covered with silica fine powder particles on the iron powder particle surface and iron loss. FIG. 5 shows experimental results indicating the relationship between the surface area covered with silica fine powder particles on the iron powder particle surface and magnetic powder particle density. As shown in the figures, in each embodiment of a magnetic powder, a single coat layer comprising silica fine powder (oxide fine powder) particles and a silicone resin (insulating coat) is formed on the surface of an iron powder (soft magnetic metal powder) particle. However, in another embodiment, silica fine powder particles are covered with a silicone resin such that two coat layers can be formed where the silica fine particles exist on the surface of a magnetic powder particle. In addition, iron powder particles have arbitrary cross sections having spherical, elliptical, and other shapes.

FIG. 1 (a) shows a cross-sectional view of a magnetic powder particle according to the present invention. A magnetic powder particle 10 in the figure comprises an iron powder particle 1 which is used as a soft magnetic metal powder particle. Silica fine powder particles 2, which are oxide fine powder particles, are dispersed in an island shape over the outer surface of the iron powder particle and fixed thereto. A silicone resin film 3 capable of becoming strongly bound to the silica fine powder particles 2 is fixed to the iron powder particle 1 and the silica fine powder particles 2 so as to serve as an insulating coat. Thus, a single insulating coat layer is formed on the surface of the iron powder particle 1.

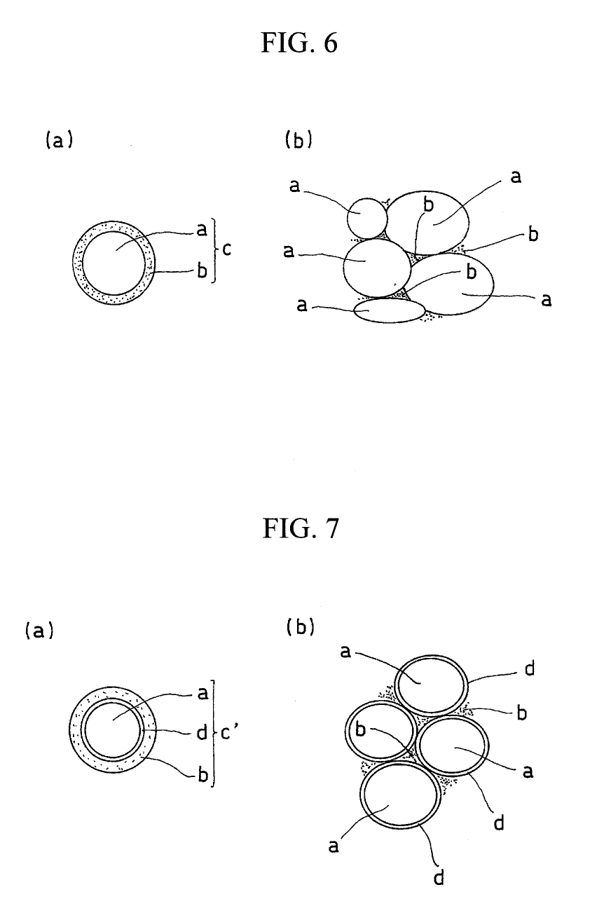

FIG. 1 (b) shows an enlarged view of a portion of a dust core that is obtained by filling a forming die with magnetic powder particles 10 and carrying out pressure forming and annealing treatment. Each of the magnetic powder particles 10 that constitute the dust core comprises silica fine powder particles 2 to which a silicone resin film 3 is strongly bound. This prevents dissolution and agglutination of the silicone resin film 3 upon high-temperature annealing. As a result, as shown in FIG. 1 (b), the surface of each magnetic powder particle 10 is covered with the silicone resin film 3 such that insulation properties of each magnetic powder particle 10 are secured. In addition, upon comparison of conventional magnetic powders shown in FIGS. 6 and 7 and the magnetic powder of the present invention, the differences therebetween are more clearly understood.

Next, the method for producing a dust core of the present invention is described based on FIG. 2. In the first step (S100), silica fine powder particles are dispersed over and fixed to the surface of each iron powder particle that is a soft magnetic metal powder particle. The step S100 is described in greater detail based on FIG. 3.

As shown in FIG. 3 (a), a silica fine powder is produced by hydrolysis of tetraethoxysilane (TEOS). More specifically, TEOS (5 g) and water (300 ml) are prepared and mixed together. The resultant is allowed to stand for the elapse of a certain period of reaction time. At such time, the resultant comprises the two separate liquids. In addition, it is possible to adjust the amount of silica fine powder in a solution by adjusting the proportion of TEOS in water. It is also possible to change the binding state of the silica fine powder to a circular or chain pattern. Alternatively, it is possible to adjust the amount of silica fine powder in a solution by allowing the solution to stand for the elapse of a certain period of reaction time. However, in order to promote hydrolysis and a complex (multiple) reaction, it is preferable to allow the solution to stand for approximately several hours to a day. As a catalyst, NaOH (0.1 g) is added to the resulting solution.

Subsequently, as shown in FIG. 3b, 100 g of iron powder (gas-atomized pure iron powder) is added to the above solution and then stirring is continuously carried out for 8 hours. Depending on the stirring time, the amount of silica fine powder that covers an iron powder varies. The longer the stirring time, the thicker the obtained silica fine powder film and the more uniform its thickness (that is to say, the coverage approaches 100%). In a case in which the stirring time is short, a thin and ununiform silica fine powder film is formed.

After the termination of stirring, filtration is carried out in a manner shown in FIG. 3 (c) for separation of the iron powder from the solution. The iron powder is air-dried for a half day. Accordingly, a powder is produced as shown in FIG. 3 (d) in a manner such that silica fine powder particles are dispersed over and fixed to the surface of an iron powder particle.

With reference back to FIG. 2, the surface of each powder particle produced in the step S100 is covered with an insulating coat of a silicone resin (step S200). Specifically, a silicone resin is melted in an ethanol solution and the powder produced in step S100 is introduced thereinto, followed by stirring. Accordingly, the silicone resin adheres to each powder particle surface. Stirring is carried out for a certain period of time and then ethanol is evaporated by stirring. Accordingly, a magnetic powder comprising the powder particles (and silica fine powder particles) each having the surface to which a silicon resin is fixed is produced.

Next, the produced magnetic powder is introduced into a forming die having a cavity formed into a certain shape of a stator core or reactor core of a motor, for example, followed by pressure forming and drying (step S300).

At the end, in order to reduce processing strain generated in the pressure-formed product, a high-temperature annealing treatment is carried out such that a dust core (not shown) is formed (step S400).

In the case of the magnetic powder of the present invention, even after the high-temperature annealing treatment is carried out in the above step S400, silica fine particles that are dispersed over and fixed to the surface of an iron powder particle are strongly bound to a silicone resin. Therefore, it is possible to solve the problem of a silicone resin being dissolved and agglutinated. As a result, a dust core having high insulation properties can be obtained.

Further, a layer that covers the surface of an iron powder particle constituting a magnetic powder particle has a single layer structure comprising silica fine particles and a silicone resin. Therefore, the iron powder proportion in the magnetic powder can be increased (realization of a high-density magnetic powder), and thus a dust core having a high magnetic flux density can be formed.

[Experimental Results Concerning the Relationship Between the Surface Area Covered with Silica Fine Powder Particles on the Iron Powder Particle Surface and Iron Loss and the Relationship Between the Same and Magnetic Powder Particle Density]

The present inventors conducted experiments relating to the relationship between the surface area covered with silica fine powder particles on the iron powder particle surface and iron loss and the relationship between the same and magnetic powder particle density. FIG. 4 shows experimental results concerning the relationship between the surface area covered with silica fine powder particles on the iron powder particle surface and iron loss. FIG. 5 shows experimental results concerning the relationship between the surface area covered with silica fine powder particles on the iron powder particle surface and magnetic powder particle density. Specifically, the experiments were conducted as follows. A magnetic powder was produced by changing the coverage of silica fine powder particles on the pure iron powder particle surface from 0% to 100%. The magnetic powder was subjected to pressure forming and annealing such that a test product (dust core) was formed. The test product was determined in terms of iron loss (hysteresis loss and eddy current loss) and density. Herein, a uniform amount of silicone resin was contained in each test product.

In FIG. 4, the dotted line (Y line), the dashed line (Z line), the solid line (X line) represent hysteresis loss, eddy current loss, and iron loss that is the sum of the two formers types of loss, respectively.

In FIG. 4, a surface cover area of 0% corresponds to a case in which no silica fine powder is contained. Also, a surface cover area of 100% corresponds to a case in which silica fine powder particles entirely cover iron powder particle surfaces.

When a silica fine powder is present, pure iron and a silicone resin can be sufficiently mixed. As a result, a magnetic powder that can secure insulation properties even after high-temperature annealing can be obtained. This results in a further decrease in eddy current loss.

However, an increase in the coverage with a silica fine powder indicates an increase in the proportion of non-iron impurities. Consequently, it has been found that an increase in the coverage with a silica fine powder is accompanied by a monotonic increase in hysteresis loss.

Further, it has been found that, when the coverage with a silica fine powder is approximately 80%, a hard silica fine powder inhibits compression formability of a magnetic powder, resulting in a decrease in the dust core density. As a result, this promotes an increase in hysteresis loss.

Meanwhile, as shown in FIG. 5, an increase in the coverage with a silica fine powder is accompanied by a monotonic decrease in the magnetic powder particle density on the vertical axis. Herein, when the coverage with a silica fine powder is approximately 80%, the dust core density sharply decreases because a magnetic powder is inhibited by a hard silica fine powder in terms of compression formability as described above.

Based on the above experimental results, it can be concluded that the coverage of the soft magnetic metal powder (iron powder) surface with an oxide fine powder (silica fine powder) is preferably 20% to 80%.

Embodiments of the present invention are described above with reference to the drawings. However, the specific constitution of the present invention is not limited to the embodiments. Therefore, the present invention encompasses any design changes or the like without departing from the spirit of the present invention.

1. A magnetic powder for a dust core, wherein relatively hard oxide fine powder particles are dispersed over and fixed to the surface of a soft magnetic metal powder particle, and wherein a relatively soft insulating coat is fixed to the oxide fine powder particles and portions where the dispersed and fixed oxide fine powder particles do not exist on the surface of the soft magnetic metal powder particle.

2. The magnetic powder according to claim 1, wherein the soft magnetic metal powder is made from pure iron.

3. The magnetic powder according to claim 1, wherein a single coat layer comprising the insulating coat and the oxide fine powder particles is formed on the surface of a soft magnetic metal powder particle.

4. The magnetic powder according to claim 1, wherein the oxide fine powder comprises silica (SiO₂) and the insulating coat comprises a silicone resin.

5. The magnetic powder according to claim 1, wherein the coverage with the oxide fine powder on the surface of a soft magnetic metal powder is 20% to 80%.

6. A dust core which is obtained via pressure forming of the magnetic powder according to claim 1.

7. A motor in which the dust core according to claim 6 is applied as a stator core and/or a rotor core.

8. A reactor in which the dust core according to claim 6 is applied as a reactor core.
